(19) United States
(12) Patent Application Publication
(10) Pub. No.: US 2010/0145502 A1
(43) Pub. Date: Jun. 10, 2010

(54) LOADING AND UNLOADING ITEMS OF FLIGHT LUGGAGE

(76) Inventor: Erich Kratzmaier, Eurasburg (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/593,852

(22) PCT Filed: Aug. 17, 2007
(86) PCT No.: PCT/EP07/58591

§ 371 Date: Jan. 25, 2010

(30) Foreign Application Priority Data
Aug. 23, 2006 (EP) 06119429.6

(51) Int. Cl. B64F 1/36; B65G 67/08; B65G 47/90; G06F 7/00

(52) U.S. Cl. 700/218; 414/809; 414/293

(57) ABSTRACT

The invention relates to the loading and unloading of items of flight luggage in an airport.

The present invention relates to a method and apparatuses for a loading and unloading of flight luggage pieces at an airport.

The handling of the luggage, which is to be loaded and unloaded, is a basic timing, logistical and technical problem with flights, particularly with passenger flights. On one hand, the considerable size of the aircrafts, which tends to increase further in the course of the technical development, and the passengers' need for comfort, as well as the economic interest regarding time saving on the other hand and, finally, also with respect to the requirement of an errorless handling of the luggage, which is to be loaded and unloaded, also regarding security and appropriate allocation, bring about high standards in this field. Basically, mechanical apparatuses with conveyor belts are applied for the transport and human workers for the loading and unloading. Specific flight luggage containers are known, which are already loaded in the luggage area of the airport and which are then loaded into and also unloaded from the aircraft as a complete container, as well as transport carriages, which are simply used for the transport of the luggage from the luggage area of the airport to the aircraft and which are unloaded there for loading the aircraft.

The problem of the present invention is to provide improved possibilities for loading and unloading flight luggage.

On one hand, the invention relates to a method for loading flight luggage into an aircraft, in which method the luggage is conveyed to a robot by a plurality of parallely working conveying belts and is loaded by the robot into a luggage container from the plurality of conveying belts, but also to a corresponding apparatus for loading of flight luggage pieces into a luggage container, which apparatus comprises a plurality of parallely working conveying belts for conveying the luggage pieces and a robot for the loading of the luggage pieces being conveyed by the plurality of conveying belts into a luggage container, furthermore, to a method for detecting the dimensions of a luggage piece, in which a hinged lever's distal end is guided along the luggage piece, wherein the lever is subjected to a force in terms of the hinged movement and wherein the displacement of the lever is evaluated while guiding it along the luggage piece, and finally, to a method for unloading a flight luggage container being loaded with flight luggage pieces, in which the luggage container is tilted around a horizontal axis and the flight luggage pieces are dumped through an opening of the flight luggage container, and a flight luggage container for such a method, which comprises at least two closable openings at opposite sides.

Preferred embodiments follow from the dependent claims and the following description. Thereby, the details refer to all aspects of the invention and to the different types of claims, this without being differentiated explicitly in detail.

According to a first aspect of the invention, a plurality of parallely working conveying belts is used in a method for loading flight luggage pieces into an aircraft. Those belts convey the luggage pieces to a robot, which is used for loading them into a luggage container. The luggage container can be a luggage container, which is unloaded once again at the aircraft, e.g. a carriage, as well as an actual flight luggage container, which is loaded to the aircraft in the state of having been loaded by the robot and is thus accordingly adapted to the aircraft in terms of construction.

The robot can be for example an articulated arm robot with a gripping tool, but can also be different in terms of construction, for example a gantry robot. It replaces the human workforce having been applied up to now, which offers timing and economical advantages.

The plurality of conveying belts shall work in parallel, thus be delivering and offering to the robot the luggage belonging to a certain flight, distributed among a plurality of belts. Likewise, either the robot can choose between luggage pieces on different belts or it can process the luggage pieces on the different belts according to specifically defined process flows. Anyway, the conveying belts do not have to retrace the working cycle of the robot identically. They can furthermore act as a buffer reservoir, so receiving larger amounts of luggage and conveying it to the robot for the subsequent “job processing”.

Preferably, the plurality of conveying belts is loaded from a common luggage belt with luggage pieces, so the conveying belts do not deliver the luggage directly from the check-in-desk to the robot. Therein, also more than a single luggage belt can be used, however, more than one conveying belt to the robot shall be loaded from each of these luggage belts at a time. Furthermore, the conveying belts being supplied by a common luggage belt can also supply more than one robot or share one robot with other conveying belts.

Preferably, there is, in terms of distributing the luggage to the plurality of conveying belts and in terms of buffering, no further sorting beyond the sorting according to flight numbers. It is absolutely reasonable to carry out a certain sorting according to flight numbers, thus allocating the luggage of a specific flight to a number of conveying belts belonging together, but not necessarily to all conveying belts belonging to a common luggage belt. The robot will have to supply the luggage pieces belonging to a flight also to a specific luggage container. On the other hand, in terms of a preferably high flexibility of the timing organization and the buffering, a distribution of the luggage pieces to the conveying belts is preferred, which is independent of further properties of the luggage, as for example its weight, its size, its susceptibility or others. Although, such boundary conditions could enable an adaption of the robot to specific types of luggage pieces or could enable another technical optimization of the loading procedure, they may, however, be contrary to the invention's primary target of optimizing the logistics with respect to timing.

Furthermore, it is preferred that the robot takes the luggage pieces in a defined cyclic order from those conveying belts, which it serves at the moment (or is serving substantially). Thereby, “cyclic” does not necessarily mean that next neighbors follow on each other. Further, “cyclic” does not mean that the robot must not remain at a specific conveying belt if there is currently more than one luggage piece, which can be taken reasonably, as they belong to the same flight and/or “fit” according to a specific packing program. However, “cyclic” shall mean that a sequence of taking the luggage pieces is always the same beside that. The advantage of this is that a conveying belt has a calculable minimum amount of time available from that point in time, at which the robot does not pick a further luggage piece from it, until that point in time, at which the robot picks a luggage piece from the belt for the next time. Likewise, a relatively large amount of time, depending on the number of conveying belts working in parallel, is available for conveying the next fitting luggage pieces and/or for receiving further luggage pieces from the supplying luggage belt.

Advantageously, the conveying belts can be built as paternoster-like belts, thus being constructed such that the luggage pieces are redirected in an upright manner to a lower strand at a deflection station at the end of the conveying belts. The conveying belts according to this invention have, in contrast to the paternoster elevator, typically elongated horizontal strands instead of vertical strands. Likewise, the luggage pieces can be conveyed in two directions with the conveying belts to achieve a higher flexibility. The conveying belt can then convey the luggage piece to the pick-up location of the robot, in the direction of the respectively shortest way, regardless of other luggage pieces standing “in front of” the dedicated luggage piece.

In one embodiment of the invention the luggage pieces are measured, namely before the loading by the robot. Likewise, the robot can already adapt to the geometry of the luggage pieces and preferably a packing plan can already be created, according to which the robot can pack the luggage container especially efficiently and densely. Thereby, as a matter of course, also further criteria can be considered, e.g. avoiding the drop-down of luggage pieces lying elevated during later transport movements of the luggage container or avoiding a “soft” luggage piece lying very low and being weighted by the luggage pieces lying above etc. However, the measuring refers at least to the geometric data of the luggage pieces and is conducted preferably on the respective conveying belt of the luggage piece and not already during check-in. Of course, the latter would also be possible, but would aggravate the integration of the invention to already existing airport setups.

This retrofit is much easier, if the arrangement of the conveying belts working parallely and the robot including the measuring of the luggage is installed at already existing luggage transport setups.

Preferably, the robot shall have the geometric data and possibly also the consistency of the luggage pieces available, even before the arrival of the luggage piece. Likewise, a packing program, which is interacting with the robot control, has the chance and time to set up an overall packing plan.

The gripping process by the robot can be simplified with respect to the complexity of the control, if the luggage pieces on each conveying belt are at least in a certain way adjusted with respect to their position. Possibly, a standardized orientation also allows gaining time. At least an alignment shall therein be performed in so far as the edges of the luggage pieces, if existing, are aligned at an angle of 0° or 90° with respect to reference edges.

Preferably, conveying by the conveying belts is performed in a stepping mode. This stepping mode refers on one hand, to the starting of a luggage piece towards the pick-up place of the robot and the stopping at this place and on the other hand, to a stopping of empty positions on the conveying belt for loading with luggage pieces being delivered subsequently. The loading and picking up of luggage pieces shall thus be performed during the standstill of the belt. The movements in between can also be continuous and do not have to be performed in a stepping mode, if the intermediate positions are not needed. Hence, the steps correspond at least to the pick-up of a luggage piece by the robot or by the luggage belt, however, they can also be performed in standardized increments, so that also steps without picking a luggage piece do exist.

Furthermore, it is preferred that an additional conveying device is provided, for instance a conveying belt, to receive luggage pieces, which are not picked up by the robot, for instance wrongly allocated or not pickable luggage pieces, or not properly picked luggage pieces, which are therefore not safely held and safely loadable to the luggage container, or luggage pieces, which cannot be put in place by the robot. This additional conveying belt can be used for receiving luggage pieces, which are dropping down, and can offer the robot a possibility to deposit such luggage pieces without further constraining its work. It can bring back the luggage pieces to an earlier step of the luggage “processing”, for example to the starting point of one of the conveying belts or even to the common luggage belt or it can also provide the luggage piece for picking-up and loading by a human worker.

Advantageously, the robot can be equipped with a gripping tool, which has a pair of gripping arms. The gripping arms can for example be hinged at a proximal end and can, with their distal end, be designed for gripping the luggage pieces. Thereto, inward pointing parts, which enable an under-gripping while picking the luggage pieces from above, can be provided at the distal end.

In this regard, it shall be emphasized that the invention is also applicable if the luggage pieces are conveyed in troughs, on trays or in any comparable open container. The luggage pieces can then be separated from these troughs or trays for example during the transfer from the common luggage belt to the conveying belts or also during the pick-up of the luggage pieces by the robot. Therein, the robot can first pick the luggage pieces with these troughs or trays or also pick only the luggage pieces, such that the troughs or trays are separated from the luggage piece by the robot or independently from the robot already before. Then, collecting or redirecting devices for the troughs or trays have to be provided. Such troughs or trays cause on one hand an additional effort, but they standardize the measures for luggage conveying within the luggage device and prevent specific problems with eyelets, straps, belts or ribbons at the luggage pieces, which could become entangled easily.

Preferably, the invention refers to the handling of flight passenger luggage.

On the other hand, the conveying belts can comprise recesses at a certain distance to each other, which facilitate the under-gripping and lifting of the luggage pieces or troughs or trays by the above described gripping arms with the inward pointing parts.

Advantageously, the aforementioned measuring of the luggage pieces can be performed with an apparatus, which has at least one lever. This lever is hinged, for instance at one proximal end, and at one end being distant to the hinge, namely the distal end, it is designed to contact the luggage piece. The distal end is guided along the luggage piece, while the lever is subjected to force in direction to the luggage piece during a relative movement between the apparatus and the luggage piece. Likewise, displacements of the lever result during the guiding along of the distal end, which provide at least the geometric measures of the luggage piece.

Preferably, this contact measurement is carried out during a translational displacement of the luggage pieces, in particular during driving on one of the conveying belts along the non-moved apparatus. Therein, the lever itself is in motion, but its hinge support is at a rest.

The lever can comprise a rolling element, in particular a rolling belt, which is preferred compared to wheels or rollers because of its larger contact area and its better adaptability to contours of surfaces. Likewise, the lever can come in contact to the luggage piece, wherein the belt is substantially stationary with respect to the surface of the luggage piece while the guiding along. The belt can also be driven and be used for a further transport of the luggage pieces.

Preferably, a pair of levers can be provided for detecting the horizontal dimensions of the luggage piece, which pair is gripping or “sampling” the luggage piece from opposite sides. Preferably, an additional third lever can be provided for capturing the vertical dimensions, which is then working relative to the contact to a conveyer device, which is running below the luggage pieces, for instance the conveying belt. As a matter of course, also a pair of levers can be provided for the vertical measurement, for instance in a clearance of the conveying belt below the luggage pieces. In addition to the geometric data, in terms of the maximal measures, the levers can also capture the contours of the luggage pieces, which can then be included in the control of the robot and its gripping tool respectively and also in the optimization of the parking plan, if necessary. Additionally, or alternatively force measurements of the levers can provide data on the consistency of the luggage piece, thus make for example soft sport bags or bag packs distinguishable from hardside suitcases.

Finally, the hinge/hinges of the lever/levers can, in addition to being hinged for a rotating motion around the rotational axis being defined by themselves, also be movable themselves, substantially perpendicular to the relative motion between the luggage pieces and the axis of the hinge, as well as substantially perpendicular to the axis of the hinge support itself. Thus, the levers can adapt to luggage piece sizes, which are strongly deviating, for instance by being adapted with their hinge first translationally, in order to take then advantage of the stroke of the rotating motion for the actual measurement.

With this embodiment, luggage pieces can also be fed from the side of the distal ends of the levers, wherein the hinges are set rather narrow. Then, the luggage piece pushes the slightly spreading levers apart and then pushes the hinges apart, to pass finally the hinges and the proximal ends of the levers being located there. This implementation is shown in the exemplary embodiment more in detail. With the modifications having been described previously, in particular with those without a translational travel of the hinges, also a reversed transport direction of the luggage pieces can be applied.

The invention also relates to the unloading of aircrafts, namely in combination with the above explanations for the loading thereof, as well as independent therefrom. Therein, the flight luggage container according to the invention is preferably tilted around a horizontal axis, wherein the flight luggage pieces can be dumped through an opening of the flight luggage container. This opening can be provided at the side or also at the top surface, preferably at one of the larger side walls. The luggage pieces can for example be dumped onto a conveying belt and can then be marshaled into pieces and aligned with the devices, which are known as such, to be supplied to the output belt for the passengers.

With a particularly simple embodiment, the flight luggage container is tilted over one of its lateral edges as horizontal axis, thus, no specific holding or hinging is needed for the tilting.

Preferably, a flight luggage container according to the invention is comprising at least two closeable openings. Conventional flight luggage containers only comprise one opening in a side wall for loading and unloading. If there is a second opening, particularly provided in the opposite side, the container can be unloaded using this second opening before it is loaded according to the invention Or conventionally using the already known opening in the front side. In particular, the unloading can be carried out using the additional opening by tilting backwards with a subsequent loading using the front opening.

Therein, the invention preferably relates to known flight luggage containers, which are designed for being loaded into the aircraft themselves and thus not for being used only for the transport of the luggage to the aircraft. These flight luggage containers have a substantially rectangular shape in the top view, the bottom view and in two opposite side views, which rectangular shape is substantially pentagonal in the two remaining opposite side views. The pentagon can be envisioned as an upright rectangular shape, of which one of the two lower edges is cut-off diagonally. Therein, the pentagonal faces form the largest side walls and comprise the conventionally known opening and, preferably at the opposite side, also the additional opening according to the invention.

In the following, the invention is described in detail with reference to an exemplary embodiment, wherein the individual features may also be important for the invention in other combinations and as aforementioned, can refer to all categories of the invention implicitly.

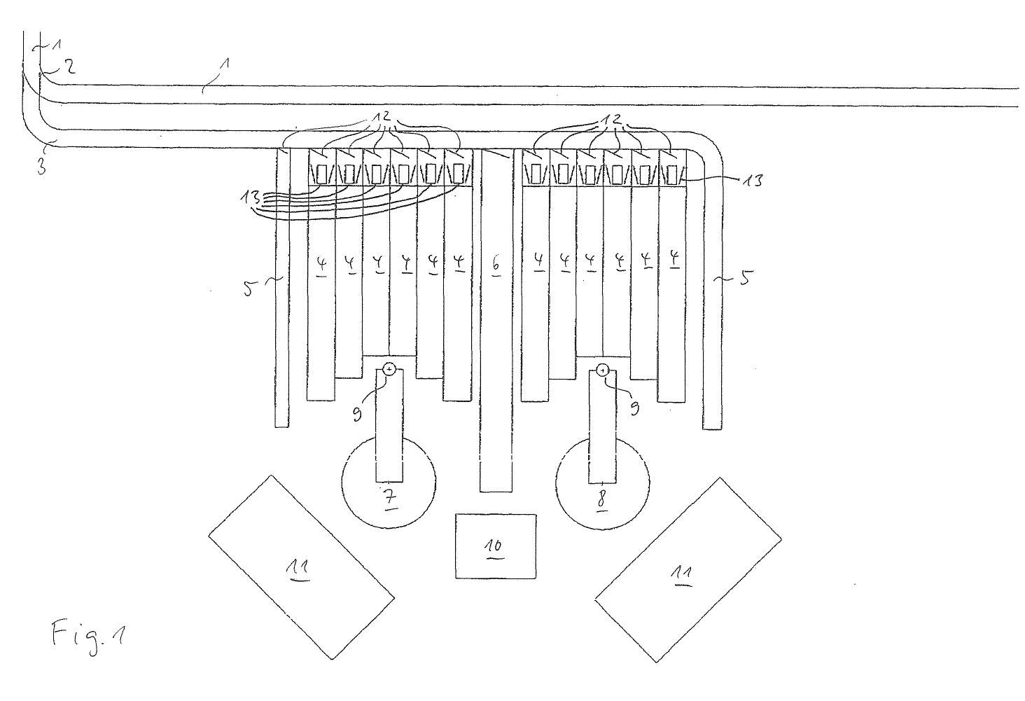

FIG. 1 shows a schematic top view of a setup according to the invention for the loading of flight luggage pieces.

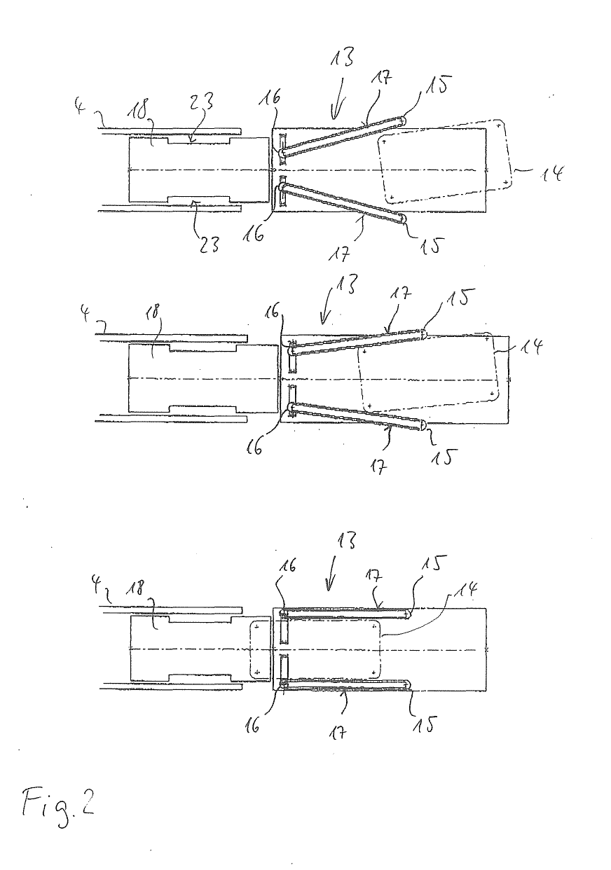

FIG. 2 shows a detailed view of FIG. 1, also in top view and at three different points in time.

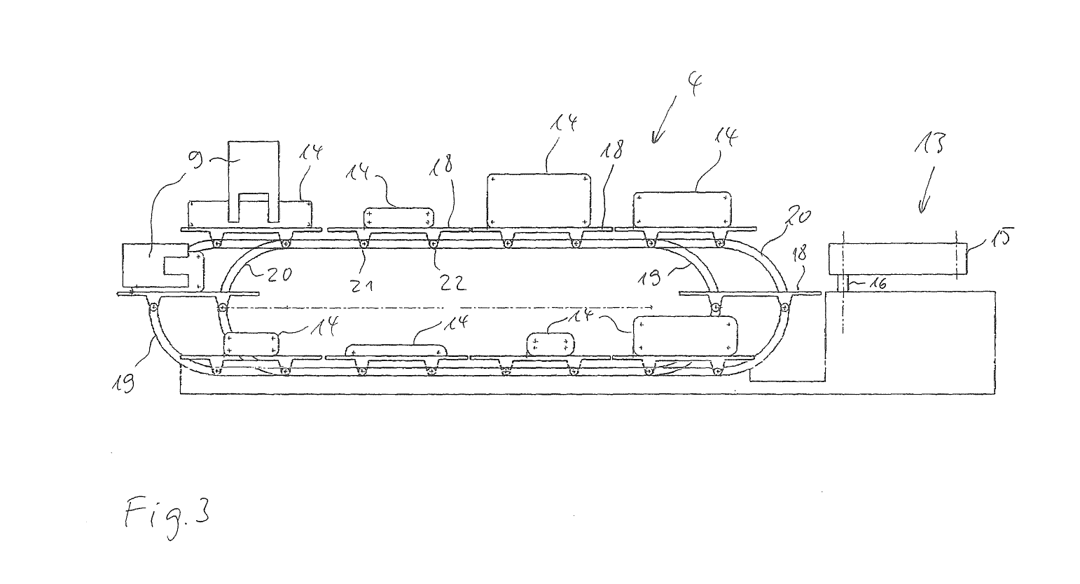

FIG. 3 shows a side view of one part of the apparatus of FIG. 1.

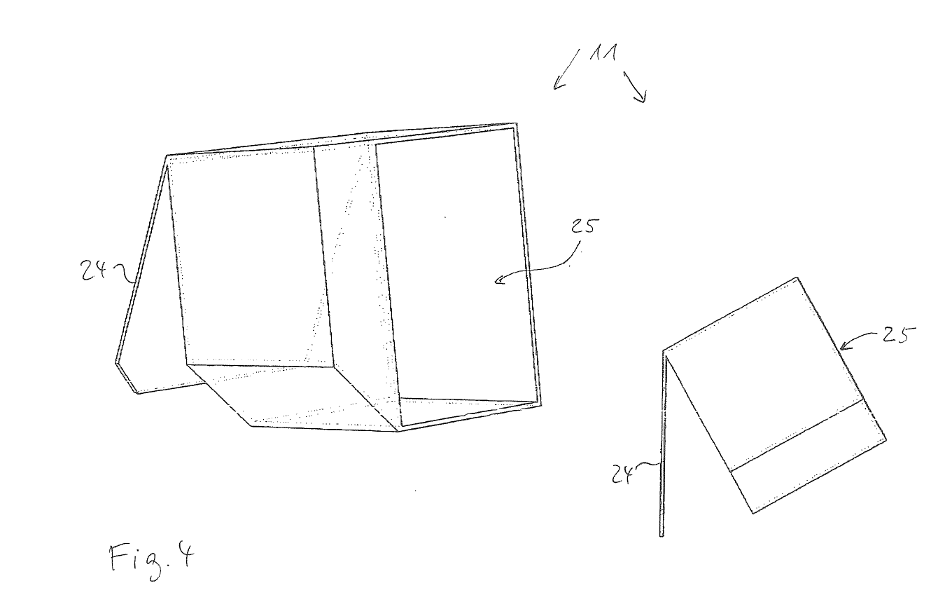

FIG. 4 shows schematically a flight luggage container according to the invention of FIG. 1.

FIG. 1 illustrates an apparatus according to the invention for the loading of flight luggage in a schematic top view and therewith also illustrates the method according to the invention.

The flight luggage is dropped off by the passengers at conventional check-in desks, where it is weighed and allocated to flight numbers and transported via conventional luggage belts. Subsequent security checks are not shown in detail here. Then, the flight luggage arrives in terms of unsorted single luggage pieces delivered one after the other via a main luggage belt 1 in the upper left area of FIG. 1. A sorting according to flight numbers is performed at a first main switch 2. The respective data is already available from the check-in desks. Here, the switch 2 is shown representative of a switch system, which is more complex in individual cases. It is used for transferring outward the luggage pieces belonging to a certain flight number to an auxiliary luggage belt 3. This runs along a system of parallely working paternoster conveying belts 4, which are explained in detail below with reference to FIG. 3. Therewith, altogether two blocks, each having six parallel conveying belts 4, are involved, which are each running perpendicular to the auxiliary luggage belt 3. Furthermore, single belts 5 for a manual loading branch off, in terms of the conveying direction, before and behind the conveying belts 4, whereby the single belts 4 can be used for special luggage pieces or in case of technical problems with the apparatus. Furthermore, there is a recirculation belt 6, which is described more in detail below, between the two blocks of paternoster conveying belts 4.

Two structurally identical robots 7 and 8, which are in this case articulated bracket robots being positioned rotatable around a vertical axis with a distal gripping tool 9, are positioned centered with respect to the two blocks of paternoster conveying belts 4 and can reach the respective ends (at the bottom in FIG. 1) of the paternoster conveying belts 4. The robots 7 and 8 are controlled by a shared system control 10, which is shown centered between the two robots 7 and 8 in this example and which contains a program for an optimization of the packing. The robots 7 and 8 are used for gripping luggage pieces from the conveying belts 4 and loading them into luggage containers 11, which are shown in the lower right and lower left respectively and which can be conventional luggage carriages for the transport to the aircraft (ramp cart), flight luggage containers of conventional type for being loaded into the aircraft (loaded with luggage) or can also be flight luggage containers being designed according to the present invention, as described above.

Individually actuable single switches 12 are provided at the “beginning” of the left single luggage belt 5 in FIG. 1, thus at the upper “end” of the conveying belts 4 in FIG. 1, and are used to transfer outward individual flight luggage pieces from the luggage belt 3. For example, the luggage belt 3 could be inclined in this region, wherein the luggage pieces are conveyed in contact to a wall and wherein the single switches 12 could be respective shutters in this wall, which can be opened and closed individually and quickly. From there, single luggage pieces drop onto one of the belts 4 and 5.

Measurement devices for the luggage pieces, referenced in summary with 13, are located on the paternoster conveying belts 4 downstream of the single switches 12. These measurement devices 13 are used for the geometric and consistency related measurement of the luggage pieces and align the luggage pieces centrally on the conveying belts 4. Below, the measurement devices are described more in detail with reference to FIG. 2.

The luggage pieces, which are dropped off at a check-in desk and are weighed and also allocated to the flight numbers, are conveyed via the luggage belt 3 to the apparatus for luggage processing of FIG. 1, which is occupied by the specific flight number. There, the luggage pieces are placed on one of the paternoster conveying belts 4 via aforehand described switches 12, which place non-processable special luggage pieces on the single luggage belt 5. Then, the luggage pieces drive on the paternoster belts 4 to the measurement device, which is shown in more detail in FIG. 2.

FIG. 2 shows a top view at three consecutive points in time, sequentially from top to bottom, wherein the single luggage piece 14 is arriving from the right and is passed through to the left. In the example shown here, the luggage piece can be a hardside suitcase.

The measurement device 13 comprises two levers 15, which are mirror-like with respect to the center axis lying horizontally in FIG. 2 and which are each hold by a hinge 16 being movable transversally to the conveying direction of the luggage piece 14. The transverse movability of the hinges 16 can be seen by comparing the three individual pictures in FIG. 2.

The levers comprise revolving belts 17. These belts are driven and are used for conveying the luggage piece, from that point in time shown in the upper picture, at which the belts have just gripped the luggage piece 14, to that point in time shown in the lower picture, at which the luggage piece 14 is pushed out of the measurement device 13 by the belts.

It is recognizable in the upper picture that the hinges 16 are first adjusted at a narrow spacing and that the levers 15 are spread apart when they pick up the luggage piece 14. Therein, the luggage piece 14 is positioned slightly oblique and is then aligned by a symmetrized movement of the levers in their hinges 16 and a symmetrized movement of the hinges 16 with respect to their transverse movability on the one hand and, is pulled into the measurement device 13 as there is increasing contact between the belts 17 and the luggage piece 14, on the other hand. Therein, the hinges 16 are moving away from each other to the distance required.

An additional lever, which is substantially constructed identically, is located above the shown setup of the two levers 15 for the purpose of a measurement of the vertical dimension of the luggage piece 14, is not shown due to graphical reasons. The measurement therewith is also possible without a corresponding counterpart, as the luggage piece 14 is lying on a transport board, which serves as a reference plane.

The measurement device shown in FIG. 2 can, in case of embayments of the luggage piece 14 (not shown), further provide a contour measurement by an inward-shifting of the hinges 16, subsequent to the last shown situation, and further, also an evaluation of the consistency by force measurements, for example in case of soft sport bags. This data can be used to optimize the planning of the loading of the luggage pieces into the luggage container 11 by the robots 7 and 8, respectively.

Subsequent to the point in time, which is shown in the last picture, the luggage piece 14 is ejected to a storage place upon a board of the corresponding paternoster conveying belt 4, which is illustrated on the left side and is referenced with numeral 18. The recesses 23 are described below.

The paternoster conveying belt 4 with the boards 18 is shown in FIG. 3 in further detail.

FIG. 3 shows a side view of a paternoster conveying belt 4 having two guide rails 19 and 20 for guiding the respective left or right supporting points 21 or 22 of the single boards 18 in FIG. 2. The guide rails enable driving the boards 18 synchronously in both directions, such that these boards can be moved constantly horizontally paternoster-like along the elongated closed oval loop forward and backward, as shown in FIG. 3. On the boards 18, several luggage pieces 14 are illustrated exemplary.

The measurement setup 13 from FIG. 2 appears only in outlines on the right side.

The gripping tool of the robots 7 and 8, which is shown in FIG. 1 only schematically and referenced with numeral 9, is sketched in FIG. 3 in two positions. It is a pair of gripping arms gripping the luggage pieces 14, in terms of FIG. 3, from top and from below, wherein the gripping arms grip the luggage piece 14 being located in the upper stand of the paternoster belt 4 from top and the luggage piece being located in the left reversing section from left, thus from the side of the robot. Both variants are possible and can be chosen according to the shape and the individual properties of the luggage piece.

Further, the gripping arms of the gripping tool 9 comprise foldable parts, which are not shown here, pointing inwards, towards the opposite gripping arm respectively, for an under-gripping of the luggage piece. The parts can be folded into a vertical and a horizontal position, respectively, thus to the bottom, when gripping from the top, and to the right, when gripping from the left, to facilitate the gripping. Also, a slightly outward pointing position can be chosen with the folding. The parts are used for the under-gripping of a luggage piece, a transport tray or a transport tub, as aforementioned, on which the luggage piece rests (not drawn), especially when gripping from top. The boards 18 and the storage places of the paternoster belt, respectively, comprise recesses at their sides for this purpose, which are visible and referenced with numeral 23 in FIG. 2.

In a simplified embodiment with non-movable parts pointing inwards of the gripping arms, the gripping arm pair could, when gripping from the left, be moved that far to the right, that these parts are positioned right of the luggage piece 14 and thus do not interfere. If the parts are foldable, they could, when gripping from the left, be folded away to provide a plane contact.

The paternoster belt 4 allows a flexible temporary buffering and uptake of luggage pieces 14 being delivered subsequently for instance onto the empty board 18 in the right part of FIG. 3, due to the forward and backward movement. Besides, the paternoster belt 4 allows an optional presentation of the luggage piece 14, which is currently appropriate for a pick-up by the robot 7 or 8, in the left section of FIG. 3. Therein, the paternoster construction is advantageous, as any luggage piece 14 can be driven to the appropriate position without rearranging other luggage pieces.

In case that single luggage pieces 14 on a paternoster belt 4 cannot be processed by the robots 7 or 8, so currently do not fit into the luggage container 11 or can not be loaded safely by the robot, these single luggage pieces 14 can be placed on and conveyed via the recirculation belt 6 to the top in FIG. 1 towards belt 3 and could be conveyed further via belt 3 to the belt portion 5. There, a human worker can handle single luggage pieces 14. Of course, also embodiments (not shown) are possible, in which “rest-belts” are running in analogy to the recirculation belt 6 below the lower “ends” of the paternoster belts 4, to pick up and convey further luggage pieces 14, which have been pushed down by the robots 7 or 8 or the paternoster belt 4.

Likewise, the paternoster belt 4 acts on one hand as an temporary buffer to level a possibly non-uniform delivery of the luggage pieces 14 by the luggage belts 1 and 3, respectively. This applies in particular with respect to the twelve parallely working paternoster belts 4 in this example. Therein, the luggage pieces are distributed by the single switches 12 to the different paternoster belts 4, only in terms of optimizing the buffer function, thus not being sorted according to further criteria and in particular not being allocated in adaption to different robot types.

On the other hand, the paternoster belts 4 are used for presenting the luggage pieces 14 in the region being accessible for the robot 7 or 8 and its gripping tool 9, being respectively requested by the central control 10 for the robot 7 or 8 in an optimized way with respect to packing order and packing arrangement in the luggage container 11. Therein, the paternoster belts 4 are processed cyclically by the respective robot 7 or 8. However, if two or more luggage pieces 14 lying next to each other on a paternoster belt are appropriate by chance, the robot 7 or 8 picks them successively before it steps to the next conveying belt 4 in the cyclic order. Consequently, the paternoster belts 4 have, in relation to the working frequency of the robot 7 and 8 respectively, relatively much time between the single pick-up processes of the robot 7 or 8 respectively, for conveying the next appropriate luggage pieces 14 forward or, if needed, for receiving subsequent luggage pieces 14 onto boards 14 that became available at the single switches and/or the measurement devices 13.

Furthermore, the two blocks consisting of six parallel paternoster convey belts each, can also be operated alternatingly. For example, the robot 7 can load the luggage from currently substantially fully loaded paternoster belts 4 of the left block into the left luggage container 11, while the right block, consisting of six paternoster belts 4 on the right and being substantially empty, is loaded via the luggage belt 3.

Furthermore, different adaptions can be made to the amount of luggage pieces being delivered by the luggage belt 3. For example, the operation of the paternoster belts 4 of one block or of both blocks can, in case of a massive amount of luggage pieces, focus on the receiving of the numerous luggage pieces, whereby the robots 7 and 8 are considered secondarily and are set to pause in intervals or temporarily completely.

Finally, also the luggage belt 3 could act as an intermediate buffer if needed.

FIG. 4 shows an embodiment of the flight luggage container 11 of FIG. 1 according to the invention. The left representation is in perspective, the right one is a side view. It can be seen that the flight luggage container 11 in FIG. 4 has a pentagonal shape, as seen from right front and left back, and a rectangular shape from the remaining sides. Therein, the pentagonal side view results from an upright standing rectangle with a cut-off edge (lower left seen from right front and lower right seen from left back). The pentagonal front side pointing rightwards to the front in FIG. 4 has in the right part a large opening 25 for loading. Further, the opening 25 can be closeable, which is not shown in FIG. 4.

As an important aspect of the invention, a further opening is added at the opposite side, wherein in this example the whole backside can be swung open. This is shown by the representation of wall 24, which is swung open at a certain angle.

The right presentation in FIG. 4 shows a side view in direction of the swinging axis, which is the edge from left top back to right top back in FIG. 4. The opened side wall 24 is swung open by gravity and points straightly downward. Thus, the lower edge is the axis for the tilting of the flight luggage container 11. No further hinging devices are necessary, but only one device which shifts and tilts the upper part of the flight luggage container 11 “backwards”, whereupon the previously unlocked wall 24 separates from the flight luggage container 11, except the upper edge, and opens the whole side wall. Likewise, flight luggage being inside a flight luggage container 11 can be dumped easily and thus be fed to a further transport and to 1n the luggage claim particularly fast and efficient.

This can happen in the position illustrated in FIG. 1, wherein transport devices not shown are used for the further transport of the dumped luggage pieces. The flight luggage container 11 is thereby directly located at the right location for the loading by the robots 7 or 8. Likewise, an especially economic combination, of unloading flight luggage from the luggage container 11 and of reloading new luggage via the opening 25, is obtained.

1. A method for loading flight luggage pieces into an aircraft,
in which said luggage pieces are conveyed by a plurality of parallely working conveying belts to a robot
and are loaded by said robot from said plurality of conveying belts into a luggage container.

2. The method according to claim 1, in which said plurality of conveying belts is loaded with said luggage pieces from a common luggage belt by respectively allocated devices for marshaling said luggage pieces into singles.

3. The method according to claim 2, in which said luggage pieces are loaded from said common luggage belt to said plurality of conveying belts being only assorted according to flight numbers.

4. The method according to claim 1, in which said robot picks up luggage pieces from said conveying belts in a cyclic order.

5. The method according to claim 1, in which said conveying belts are constructed as paternoster belts and are operated in two directions of movement while conveying said luggage pieces to said robot.

6. The method according to claim 1, in which said luggage pieces are, prior to the loading by the robot and preferably on the respective conveying belt, geometrically measured and the geometric measurement data is used for controlling of the loading procedure being carried out by said robot.

7. The method according to claim 1, in which said luggage pieces are position-adjusted on said respective conveying belt.

8. The method according to claim 1, in which said plurality of conveying belts are driven in a stepping mode, wherein preferably each step corresponds to the pick-up of a luggage piece.

9. The method according to claim 1, in which an additional conveying device is provided, which can receive the luggage pieces being not picked up by said robot, being not picked up correctly by said robot, or being not storable.

10. The method according to claim 1, in which said luggage container is unloaded at said aircraft itself.

11. The method according to claim 1, in which said luggage container itself is loaded into said aircraft with said luggage pieces.

12. The method according to claim 1, in which said robot comprises a gripping device, which is equipped with a pair of gripping arms, wherein an inward pointing part at the distal end of each said gripping arm is provided for an under-gripping of said luggage pieces.

13. The method according to claim 12, in which said conveying belts comprise recesses to facilitate said under-gripping of said luggage pieces by said gripping device of said robot.

14. An apparatus for loading of luggage pieces into a luggage container, which apparatus comprises
a plurality of parallely working conveying belts for conveying said luggage pieces and
a robot for loading said luggage pieces being delivered by said plurality of conveying belts into said luggage container.

15-30. (canceled)
